(19) United States
(12) Patent Application Publication
(10) Pub. No.: US 2013/0239093 A1
(43) Pub. Date: Sep. 12, 2013

(54) PARALLELIZING TOP-DOWN INTERPROCEDURAL ANALYSIS

(71) Applicants: Aditya V. Nori, Bangalore (IN); Sriram K. Rajamani, Bangalore (IN); Rahul Kumar, Redmond, WA (US); Aws Albarghouthi, Toronto (CA)

(72) Inventors: Aditya V. Nori, Bangalore (IN); Sriram K. Rajamani, Bangalore (IN); Rahul Kumar, Redmond, WA (US); Aws Albarghouthi, Toronto (CA)

(73) Assignee: Microsoft Corporation, Redmond, WA (US)

(21) Appl. No.: 13/415,850

(22) Filed: Mar. 9, 2012

(51) Int. Cl. G06F 9/44

(52) U.S. Cl. 717/126

(57) ABSTRACT

Technologies pertaining to top-down interprocedural analysis of a computer program are described herein. A query is received for processing over a root procedure in the computer program. Responsive to the query being received, the root procedure is explored, and calls to sub-procedures are located. Sub-queries are generated upon encountering the calls to the sub-procedures, and execution of the sub-queries is performed in parallel across multiple computing nodes.

### BACKGROUND

As computer programs have continued to increase in complexity, importance of program verification has likewise increased. For example, many programs have hundreds of thousands or even millions of lines of code, and prior to such a program being deployed, it is often desirable to verify that the program will operate as intended by its developers. It is to be understood that program verification differs from location of bugs in computer-executable code. For example, an error exists in the source code that would not allow the resulting program to be interpretable by a computer processor, typically a compiler will include bug checking functionality that identifies the errors in the source code. In many cases, however, the program that includes no bugs may still not operate as intended by its developers. This is especially true when multiple developers are modifying different parts of code at different geographic locations.

There generally exists two different types of program verification tools; the first type is a static analysis tool that performs program verification without actually executing the program. In contrast, dynamic program analysis is the analysis of computer-executable code when such code is executed. Thus, dynamic program analysis is performed by executing a program built from desirably tested code on a real or virtual processor. Generally, this involves ascertaining test inputs to provide to the executing program, such that the behavior of the program with the test inputs can be observed.

In conventional program verification that utilizes static analysis, two techniques are typically employed. The first technique can be referred to as a bottom-up analysis. A bottom-up analysis is performed by processing a call graph of a computer program upwards from the leaves of the call graph. Therefore, for example, in a bottom-up analysis, before a procedure Pᵢ is analyzed, sub-procedures that are called by Pᵢ are analyzed, and for each sub-procedure a summary is computed, typically without considering be calling context of the respective sub-procedure. During the analysis of Pᵢ, the summary of a called sub-procedure is utilized to calculate the effects of calling the sub-procedure (instead of the body of the sub-procedure). An inherent advantage of bottom-up analysis is its modularity, as there is decoupling between callers of a procedure and the analysis of the body of such procedure.

In contrast, a top-down analysis begins from the root of the call graph for a program, and proceeds downward such that each procedure in the program is analyzed in the context in which it is called. It can be ascertained that a program verification tool that utilizes top-down analysis is typically more precise than program verification tools that utilize bottom-up analysis. As each analysis of a program procedure is undertaken with respect to its calling context, the summary for such context is caused to be relatively precise. A trade-off to the increased precision of top-down analysis, however, has been the lack of modularity when performing such analysis.

### SUMMARY

The following is a brief summary of subject matter that is described in greater detail herein. This summary is not intended to be limiting as to the scope of the claims.

Described herein are various technologies pertaining to parallelizing top-down interprocedural analysis of a computer program. Computer programs can be represented by a call graph, wherein nodes of the call graph represent procedures (methods), and a directed edge between a first node and a second node represents a call from the procedure represented by the first node to a procedure represented by the second node. It can therefore be ascertained that a root node in the call graph represents a main procedure in the computer program, while the remaining nodes represent sub-procedures in the computer program. Described herein are technologies which employ a map/reduce style parallelism to scale top-down analysis of the computer program.

In operation, a program that is desirably subjected to a top-down analysis can be retained in a data store, and a query that is desirably executed over such program can be received. For example, the query can be formulated to ascertain whether the program ever reaches a particular state, to ascertain whether it is possible for a certain procedure to be reached, or the like. An intraprocedural analysis algorithm can then process the query (referred to as a main query) over the main procedure of the computer program (the procedure represented by the root node in the call graph). The intraprocedural analysis algorithm can explore paths in the main procedure of the computer program (forward, backward, or some combination of forward and backward). When the analysis algorithm encounters a method call to a sub-procedure, such algorithm automatically formulates a sub-query for the sub-procedure, wherein a result of the sub-query is needed to answer the main query. A summary of the respective sub-procedure can be searched for in a database of summaries in connection with answering the sub-query. If a summary for such sub-procedure is located, the sub-query can be answered utilizing the summary and processing can continue. If there is no suitable summary for the sub-procedure, then the sub-query can be transitioned to a Ready state and added to a set of queries to be returned. Subsequently, other paths in the main procedure are explored, and the same strategy is repeated, thereby generating multiple sub-queries that are to be executed over respective sub-procedures. The processing of the main query over the main procedure halts when further analysis is unable to be performed without obtaining answers to the sub-queries.

After a plurality of sub-queries have been formulated and returned, such sub-queries can be scheduled for execution in parallel across multiple computing nodes. A computing node may be a processor core and accessible memory, a processor and accessible memory, an independent computing device (e.g., a personal computing device, a server), or the like. It can be ascertained that the multiple computing nodes can process the sub-queries in parallel. The process of formulating sub-queries and returning results (if possible) is repeated until there is sufficient information to answer the main query.

Other aspects will be appreciated upon reading and understanding the attached figures and description.

### BRIEF DESCRIPTION OF THE DRAWINGS

FIG. 1 is a functional block diagram of an exemplary system that facilitates parallelizing interprocedural top-down analysis of a computer program.

FIG. 2 is a functional block diagram of an analysis component that can perform an intraprocedural analysis on a procedure of a computer program.

FIG. 3 is an exemplary computer program.

FIG. 4 is an exemplary state machine that illustrates possible states of a query that is to be executed over a procedure of a computer program.

FIG. 5 is an exemplary depiction of an interprocedural top-down analysis over the computer program shown in FIG. 3.

FIG. 6 is a flow diagram that illustrates an exemplary methodology for performing an interprocedural top-down analysis of a computer program.

FIG. 7 is an exemplary computing system.

### DETAILED DESCRIPTION

Various technologies pertaining to parallelizing a top-down interprocedural analysis of a computer program will now be described with reference to the drawings, where like reference numerals represent like elements throughout. In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components. Additionally, as used herein, the term “exemplary” is intended to mean serving as an illustration or example of something, and is not intended to indicate a preference.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

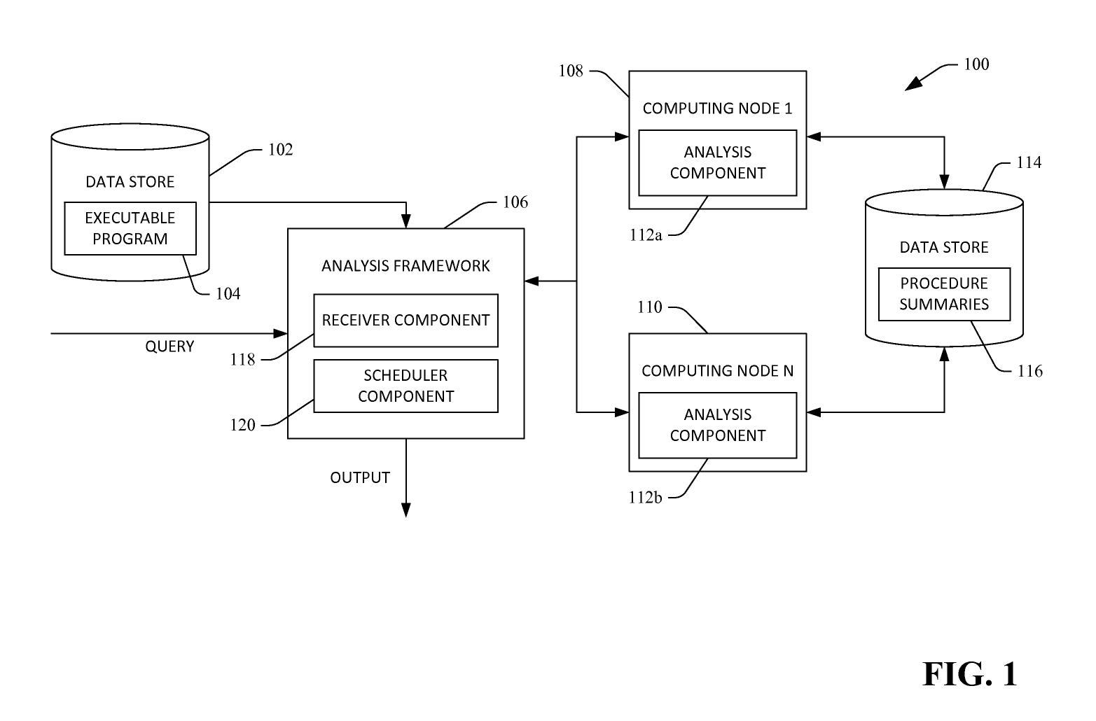

With reference now to FIG. 1, an exemplary system that facilitates parallelizing top-down interprocedural analysis of a computer program is illustrated. The system 100 comprises a data store 102, which can be any suitable computer-readable data storage device, including but not limited to memory of a computing device, a hard drive, a removable disk, a flash drive etc. The data store 102 comprises an executable program 104 that is written in a suitable language. For example, the executable program 104 can be written in C, C+C++, C#, or the like. In an exemplary embodiment, the executable program can be a device driver. The executable program 104, as will be understood by one skilled in the art, can be represented through utilization of a call graph, where nodes of the call graph represent procedures (methods), while directed edges represent calls between procedures. A root node in the call graph, therefore, represents a main procedure of the executable program 104 while other nodes in the call graph represent sub-procedures.

The system 100 further comprises an analysis framework 106 that receives the executable program 104 and a query that is desirably executed over the executable program 104. The analysis framework 106 facilitates parallelizing top-down interprocedural analysis of the executable program 104 based at least in part upon the query. In an example, the query can be constructed to ascertain whether the executable program 104 can, during execution thereof, reach a particular intermediate state or output state (e.g. whether certain values of variables in the executable program 104 can be in a range specified in the query). In another example, the query can be a reachability query, wherein it is desirable to understand whether the executable program 104 ever reaches a certain function (e.g. an error function).

The system 100 further comprises a plurality of computing nodes 108-110 that are in communication with the analysis framework 106. While shown as being separate therefrom, it is to be understood that all or portions of the analysis framework 106 may be included in one or more of the computing nodes 108-110. In an exemplary embodiment, a computing node, as the term is used herein, can refer to a core of a processor and memory that is accessible by such core. In another example, a computing node can refer to a processor and memory that is accessible by the processor. In still yet another example, a computing node can refer to an entirety of a computing device (a server, a personal computing device, etc.). In still yet another example, a computing node may be a system on a chip (SoC) or a cluster on a chip (CoC). Still further, a computing node may be a virtual processor and corresponding virtual memory in a virtualized system.

Each of the computing nodes 108-110 has an analysis component 112a-112b, respectively (collectively referred to as analysis component 112). The analysis component 112 is and intraprocedural analysis algorithm which, as will be described below, can be configured to formulate queries as well as execute a query over a procedure in the executable program 104.

The system 100 further comprises a data store 114 that retains procedure summaries 116. While shown as being different from the data store 102, it is to be understood that a data store or series of distributed data stores can retain the executable program 104 and the procedure summaries 116. The data store 114 is accessible to each of the computing nodes 108-110 and is further accessible to the analysis framework 106. As will be understood, a procedure summary can represent potential output states of a procedure with respect to a corresponding calling context of such procedure. In an exemplary embodiment, the analysis component 112 can be configured to generate a procedure summary responsive to receipt of an identity of a particular procedure and a query that is to be executed over such procedure. Furthermore, the analysis component 112 can output an answer to a query based at least in part upon a procedure summary in the procedure summaries 116 of the data store 114. For example, the analysis component 112 can receive a particular procedure and a query that is to be executed over such procedure. Execution of the query, however, may require obtaining a summary of a sub-procedure that is called by such procedure. The analysis component 112 can access the data store 114 and retrieve the requisite summary and can output an answer to the query based at least in part upon the summary of the sub-procedure that is called by the procedure. Furthermore, in such a case, the analysis component 112 can generate a summary for the procedure (which is based upon the summary of the sub-procedure called by the aforementioned procedure), and can cause such summary to be retained in the data store 114 such that the summary can be accessed by other executing instantiations of the analysis component 112.

The analysis framework 106 comprises a receiver component 118 that receives the executable program 104, which, as described above, comprises a main procedure and a plurality of sub-procedures. The receiver component 118 additionally receives the query, which can be referred to herein as a main query, wherein the main query is desirably executed over the executable program 104. The analysis framework 106 also comprises a scheduler component 120 that, responsive to receipt of the main query, assigns computing tasks across the plurality of computing nodes 108-110, wherein the computing tasks are to be executed in parallel. Each of the computing nodes 108-110 is assigned a computing task for a different respective sub-procedure in the executable program 104. The scheduler component 120 can schedule the computing tasks to execute on the computing nodes 108-110 in parallel, wherein execution of such computing tasks in parallel results in performance of a top-down interprocedural analysis of the executable program 104. The analysis framework 106 may then output a result of such interprocedural analysis (a result of the main query executed over the executable program 104).

As will be described in greater detail below, the scheduler component 120 can comprise or be in communication with the analysis component 112, and responsive to receipt of the query, can perform an intraprocedural analysis on the main procedure in the executable program 104. The analysis component 112 can explore paths in the main procedure (forward, backward, or some combination of both). The analysis component 112 can employ and overapproximate analysis, an underapproximate analysis, or some combination thereof. When the analysis component 112 encounters a call to a sub-procedure in the main procedure, it automatically formulates a sub-query for the sub-procedure, wherein results of the sub-query are needed to answer the original query (the main query). The analysis component 112 first accesses the procedure summaries 116 to determine if a summary resides therein that can be employed to answer the sub-query. If the analysis component 112 locates such a summary, the analysis component 112 outputs a result for the sub-query using such summary. Otherwise, the analysis component 112 assigns a Ready state to the sub-query, and adds it to a set of queries that will be returned. The analysis component 112 then continues to explore paths in the main procedure, repeating the same strategy to handle any procedure calls it encounters on such paths. The analysis component 112 completes processing of the main query when such component 112 cannot perform any further analysis on the main procedures without obtaining answers to sub-queries formulated by the analysis component 112.

The analysis component 112 than returns all sub-queries it has generated (which are in the Ready state) as well as the main query, which is set to a Blocked state. The scheduler component 120 receives the list of sub-queries and schedules processing of such sub-queries over their respective sub-procedures across the computing nodes 108-110. The analysis component 112 (instantiated separately on the different computing nodes 108-110) processes the respective sub-queries in parallel, and can generate additional queries to other procedures called in such sub-procedures. Eventually, parent queries are answered, and the process continues until the main query returns an answer (output).

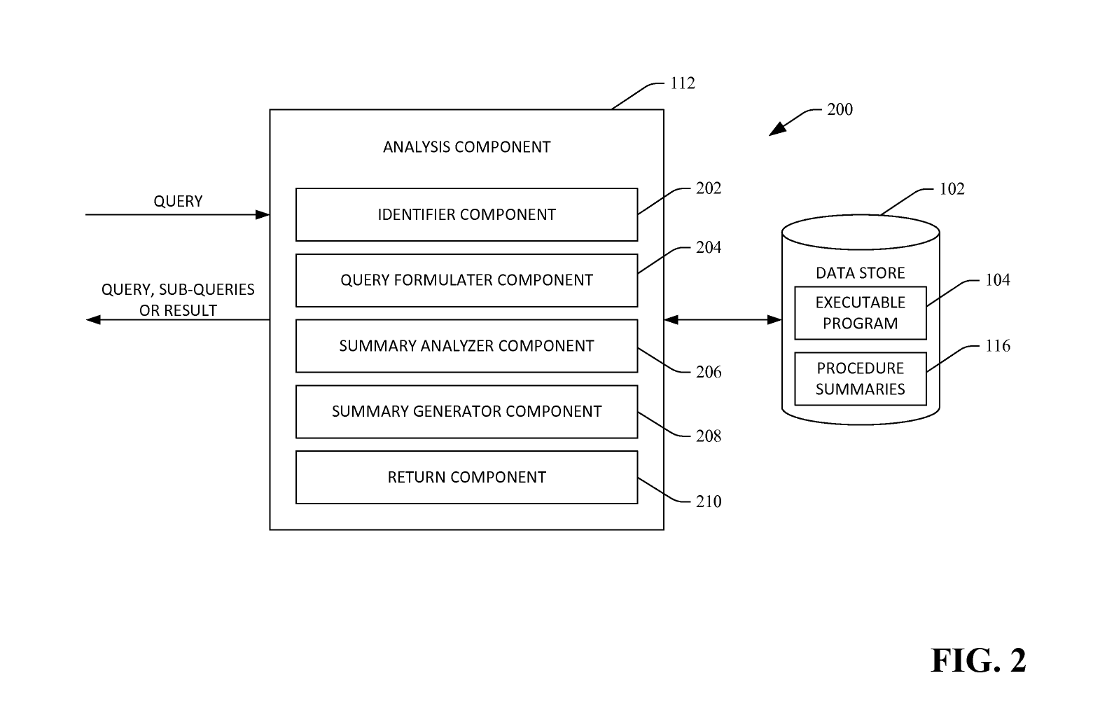

With reference now to FIG. 2, an exemplary depiction 200 of the analysis component 112 is shown. The analysis component 112 is in communication with the data store 102, which is shown to comprise the executable program 104 and the procedure summaries 116. The analysis component 112 comprises an identifier component 202 that receives a procedure in the executable program 104 and identifies calls to other procedures (sub-procedures) in such procedure. As described above, the identifier component 202 can explore paths in the identified procedure forward, backwards, or some combination thereof. The analysis component 112 further comprises a query formulator component 204 that can, responsive to the encountering a call to a sub-procedure in the procedure, formulate a query that, when executed over the sub-procedure, returns an output utilized to process the received query over the parent procedure. The query formulator component 204 can use any suitable technique in connection with formulating sub-queries.

The analysis component 112 further comprises a summary analyzer component 206 that, responsive to the query formulator component 204 formulating a sub-query, accesses the data store 102 to ascertain whether the sub-query can be answered utilizing a procedure summary in the procedure summaries 116. If such a procedure summary exists in the data store 102, the analysis component 112 can answer the sub-query utilizing the located summary and can continue processing the received query over the procedure. Otherwise, the analysis component 112 can add the sub-query generated by the query formulator component 204 to a list of sub-queries that are to be returned.

The analysis component 112 may also comprise a summary generator component 208 that, for example, can generate a summary for the procedure if the procedure is a leaf node in the call graph or if the summary can be computed based upon summaries that are retrievable from the data store 102. If the summary generator component 208 generates a summary for the procedure, such summary can be added to the procedure summaries 116 in the data store 102.

The analysis component 112 further comprises a return component 210 that returns the received query and sub-queries that need to be process to answer the received query to the scheduler component 120. If the analysis component 112 is able to answer the received query over the procedure (using one or more summaries from the data store 102 and/or a summary generated by the summary generator component 208), such result can be returned to the scheduler component 120. As discussed above, once the analysis framework 106 receives sufficient answers to sub-queries, the main query can be answered.

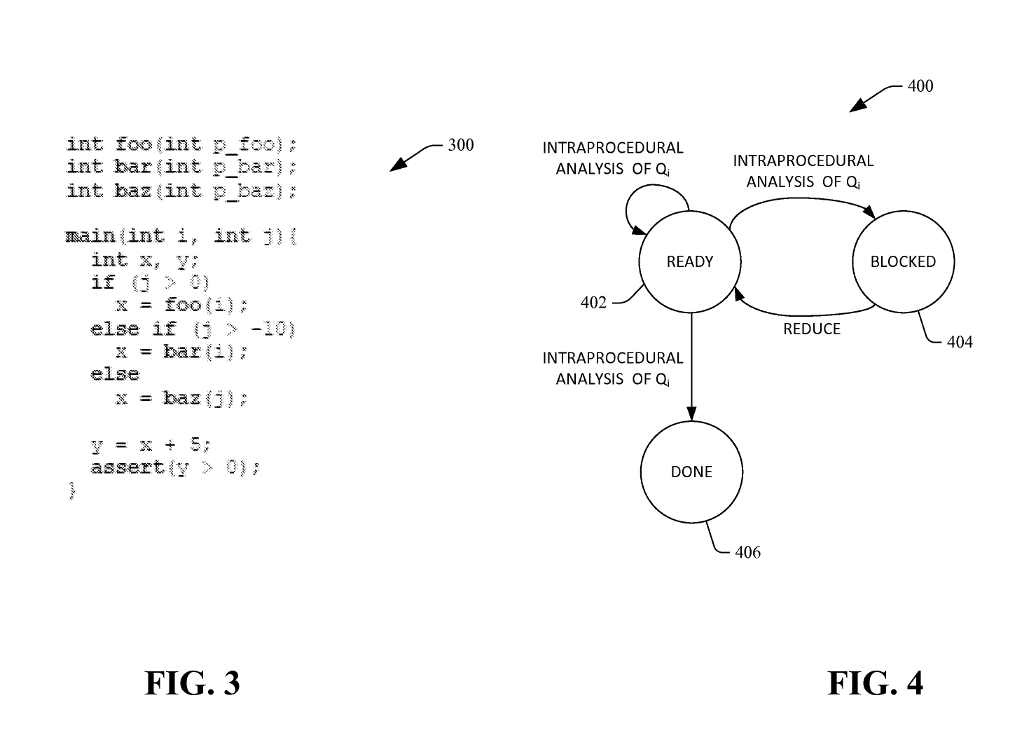

Now referring to FIG. 3, an exemplary computer program 300 that may be subject to parallelized top-down interprocedural analysis is shown. The program 300 comprises a main procedure main, and the procedure main invokes three other procedures: bar, foo, and baz (which only have their signatures shown). In this example, it is desirable to ascertain whether some input to main exists that violates the assertion “assert(y>0)” at the end of main. Such check can be encoded as the following query over the procedure main:

Qₘₐᵢₙ= [symbol] true [symbol] ₘₐᵢₙ y≦0 [symbol] (1)

This query is configured to ascertain whether there is an execution through the procedure main starting in any input state (denoted by the precondition true) and ending in a state satisfying the error condition y≦0.

With reference now to FIG. 4, an exemplary state diagram 400 illustrating possible states of a query Qᵢ is shown. The query Qᵢ is placed in a Ready state 402 when it is ready to be processed (e.g., when it is ready to be executed over a procedure Pᵢ by the analysis component 112). As described above, the analysis component 112 formulates a query Qⱼ that is to be executed over a procedure Pⱼ called by the procedure Pᵢ. If the analysis component 112 is unable to provide an output to the query Qᵢ (due to lack of a summary S_{P}_{ⱼ} of procedure Pⱼ called by Pᵢ), then the query Qᵢ is transitioned to a Blocked state 404, and the query Qⱼ is added to a list of queries to be returned to the scheduler component 120. The returned queries are then placed in the Ready state 402. Alternatively, if the analysis component 112 has sufficient information pertaining to all sub-procedures called by procedure Pᵢ to generate a summary S_{P}_{ᵢ} for procedure Pᵢ, then the analysis component 112 outputs an answer to the query Qᵢ (e.g., returns the answer to the scheduler component 120), stores the summary S_{P}_{ᵢ} in the procedure summaries 116, and transitions Qᵢ to a Done state 406.

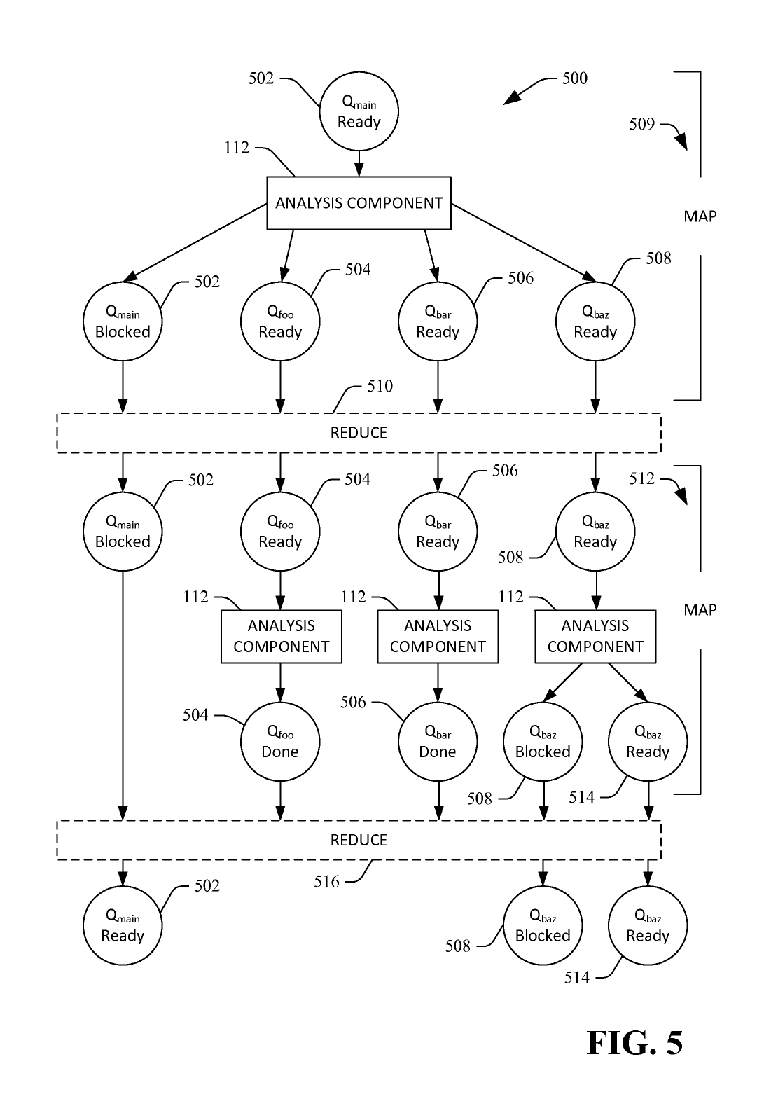

With reference now to FIG. 5, an exemplary depiction 500 of a parallelized top-down interprocedural analysis of the program 300 is illustrated. The depiction 500 shows alternating between MAP and REDUCE stages for query formulating and processing. The analysis framework 106 can operate, in this example, by first applying the analysis component 112 to Qₘₐᵢₙ 502 over the procedure main. The query Qₘₐᵢₙ 502 is initialized in the Ready state 402 (e.g., ready to be processed). Processing of Qₘₐᵢₙ 502 by the analysis component 112 results in new queries Q_{foo} 504, Q_{bar} 506, and Q_{baz} 508. Such initial processing of the query Qₘₐᵢₙ 502 occurs in a first MAP stage 509. The queries Q_{foo} 504, Q_{bar} 506, and Q_{baz} 508 can be referred to as children of Qₘₐᵢₙ 502, and are all in the Ready state 402. Examples of such queries are as follows:

Q_{foo}= [symbol] true [symbol] _{foo} ret≦−5 [symbol] (2)

Q_{bar}= [symbol] true [symbol] _{bar} ret≦−5 [symbol] (3)

Q_{baz}= [symbol] p_{baz}≦−10 [symbol] _{baz} ret≦−5 [symbol] (4)

In this example, the intraprocedural analysis undertaken by the analysis component 112 over main using Qₘₐᵢₙ 502 results in the ascertainment that the assertion “assert(y>0)” in main holds if and only if each of the procedures foo, bar, and baz return a value greater than −5. It can be noted that Q_{baz} 508 has the precondition to p_{baz}≦−10, since baz is only called with inputs less than or equal to −10.

Responsive to the queries Q_{foo} 504, Q_{bar} 506, and Q_{baz} 508 being returned, query Qₘₐᵢₙ 502 is placed in the Blocked state 404, because results from execution of at least one of its child sub-queries is needed before the query Qₘₐᵢₙ 502 can make progress over main. A first REDUCE stage 510 is then initiated, where the analysis component 112 analyzes if any interdependencies between the queries Q_{foo} 504, Q_{bar} 506, and Q_{baz} 508 have been resolved. In this example, none are resolved, so each query remains in its respective state (the first reduce stage 510 is essentially a no-op). At this point, the scheduler component 120 can schedule execution of the queries, Q_{foo} 504, Q_{bar} 506, and Q_{baz} 508 over respective procedures foo, bar, and baz across differing computing nodes.

In a second MAP stage 512, the analysis component 112 is executed, in parallel, on different computing nodes, such that the analysis component 112 executes queries in the Ready state 402 over their respective procedures. Accordingly, in an example, the analysis component 112 on a first computing node can execute the query Q_{foo} 504 over foo, the analysis component 112 on a second computing node can execute the query Q_{bar} 506 over bar, and the analysis component 112 on a third computing node can execute the query Q_{baz} 508 over baz. For sake of explanation, the queries Q_{foo} 504 and Q_{bar} 506 can be entirely processed during the second MAP stage 512 (perhaps due to foo and bar being leaf nodes in the call graph of the program 300), and accordingly such queries are transitioned to the Done state 406. Results of queries transitioned to the Done state 406 can be retained as procedure summaries in the procedure summaries 116. As will be understood by one skilled in the art, a procedure summary can be a must summary (representing an underapproximation of the procedure and containing a path to error states), or a not-may summary (representing an overapproximation of the procedure and excluding paths to error states). The procedure baz calls the procedure roo; when executing Q_{baz} 508 over baz, the analysis component 112 can formulate a new query Qᵣₒₒ 514 that needs to be executed over roo before Q_{baz} 508 can generate a result. During the MAP stage 512, Q_{baz} 508 is moved to the Blocked state 404, and Qᵣₒₒ 514 is placed in the Ready state 402.

During a second REDUCE stage 516, since Q_{foo} 504 and Q_{bar} 506 have moved to the Done state 406, Qₘₐᵢₙ is placed in the Ready state 402, thereby enabling Qₘₐᵢₙ to be further processed by the analysis component 112 over main. Queries that have transitioned to the Done state 406 are also deleted (as well as all of their respective descendants); accordingly, in this example, the queries Q_{foo} 504 and Q_{bar} 506 are deleted during the second REDUCE stage 516.

In subsequent stages (not shown in FIG. 5), it is possible that Qₘₐᵢₙ 502 can complete based upon answers received from the processing of Q_{foo} 504 and Q_{bar} 506. If this occurred, then a subsequent reduce stage will garbage collect the remaining queries (Q_{baz} 508 and Qᵣₒₒ), since results of such queries are no longer required. In other words, it is possible that a parent query can be answered based upon results of a subset of its child queries.

Returning now to FIG. 1, a more detailed description of operation of the analysis framework 106 and the analysis component 112 is provided. The data store 102 comprises the executable program 104, which will be referred to as program [symbol] . The program [symbol] is a set of procedures {P₀, . . . , Pₙ), where P₀ is the main procedure (entry point) of [symbol] . A procedure Pᵢ is a tuple (Vᵢ, Nᵢ, Eᵢ, nᵢ⁰, ηᵢ^{x}, λᵢ), where:
Vᵢ is the disjoint union of the set of local variables Vᵢ^{L} of Pᵢ and the set of global variables V_{G} of [symbol] .
Nᵢ is the set of control nodes (locations).
Eᵢ: Nᵢ×Nᵢ is the set of edges between control nodes.
βᵢ⁰, nᵢ^{x} ∈ Nᵢ are the entry and exit locations, respectively.
λᵢ: Eᵢ→Stmt is a labeling function, where Stmt is the set of program statements over Vᵢ. Statements in Stmt can be either simple statements or call statements, wherein a simple statement in a procedure Pᵢ is an assignment statement x=E or an assume statement assume(Q), where x is a variable in Vᵢ, E is an expression over the variables Vᵢ, and Q is a Boolean expression over the variables Vᵢ. A call statement to the procedure Pⱼ is of the form call Pⱼ.

It can be assumed, without loss of generality, that communication between procedures is performed via the global variables V_{G}, and for each procedure Pᵢ, there need not exist a node n ∈ Nᵢ such that (nᵢ^{x}, n) ∈ Eᵢ.

An exemplary program model will now be described. A configuration of a procedure Pᵢ is a pair (n, σ), where n ∈ Nᵢ, and the state σ is a valuation of variables Vᵢ of Pᵢ. The set of all states Pᵢ is denoted by Σ_{P}_{ᵢ}. Every edge e ∈ Eᵢ is a relation Γₑ ⊂ Σ_{P}_{ᵢ}×Σ_{P}_{ᵢ} defined by the standard semantics of the statement λᵢ(e).

The initial configurations of a procedure Pᵢ are {(nᵢ⁰, σ)|σ ∈ Σ_{P}_{ᵢ}}. From a configuration (n, σ), Pᵢ can execute a statement by traversing some edge e=(n, n′) ∈ Eᵢ and reaching a configuration (n′, σ′), where (σ, σ′ ∈ Γₑ). A configuration of (n, σ) can reach another configuration (n′, σ′), where n, n′ ∈ Nᵢ, if and only if there exists a sequence of edges in (n, n₁), (n, n₂), . . . , (nₘ, n′) ∈ Eᵢ, which, if executed from state σ leads to state σ′.

Procedure summaries that can be generated by the analysis component 112 and retained in the procedure summaries 116 are now described. For any procedure Pᵢ, φ₁ and φ₂ can be formulae representing sets of states in 2^{Σ}^{_{Pi}}. Then, there can exist two types of summaries for Pᵢ: must summaries and not-may summaries, defined respectively as follows:
Must Summary: [symbol] φ₁ [symbol] Pᵢφ₂ [symbol] is a must summary for Pᵢ if and only if every exit configuration (nᵢ^{x}, σ′), where σ′ ∈ φ₂, is reachable from some initial configuration (nᵢ⁰, σ), where σ ∈ φ₁.
Not-may Summary: [symbol] φ₁ [symbol] Pⱼφ₂ [symbol] is a not-may summary for Pᵢ if and only if every initial configuration (nᵢ⁰, σ), where σ ∈ φ₁, cannot reach any exit configuration (nᵢ^{x}, σ′), where σ′ ∈ φ₂.

Queries that can be executed over procedures are now described. A query Qᵢ over some procedure Pⱼ is defined as a 4-tuple (qᵢ, sᵢ, pᵢ, [symbol] ᵢ), where
qᵢ is a reachability question of the form [symbol] φ₁ [symbol] Pⱼφ₂ [symbol] , asking if a procedure Pⱼ starting in a configuration in {(nⱼ⁰, σ)|σ ∈ φ₁} can reach a configuration in {(nⱼ^{x}, σ)|σ ∈ φ₂}.
sᵢ ∈ {Ready, Blocked, Done} is the query state.
pᵢ is the index of the parent query Q_{P}_{ᵢ} of Qᵢ.
[symbol] ᵢ is a verification object that maintains the internal state of a query. The exact nature of such an object depends on a kind of analysis being performed by the analysis framework 106 (may-analysis, must-analysis, may-must-analysis).

A procedure summary S can be used to answer a reachability question
[symbol] φ₁ [symbol] Pⱼφ₂ [symbol] in either of the following ways: 1) Answer=“yes”, if
S= [symbol] \hat{φ}₁ [symbol] Pⱼ\hat{φ}₂ [symbol] , where \hat{φ}₁ ⊂ φ₁ and φ₂ ∩ \hat{φ}₂≠0; 2) Answer=“no”, if
S= [symbol] \hat{φ}₁ [symbol] Pⱼ\hat{φ}₂ [symbol] , where φ₁ ⊂ \hat{φ}₁ and φ₂ ⊂\hat{φ}₂.

Intuitively, a must-summary S answers a reachability question [symbol] φ₁ [symbol] Pⱼφ₂ [symbol] with a “yes, there is an execution from a state in φ₁ to a state in φ₂ through Pⱼ.” On the other hand, if S is a not-may summary, then it answers the reachability question with a “no, there are no executions through Pⱼ from any state in φ₁ to any state in φ₂.”

A verification question for a program [symbol] is a query Q₀=(q₀, s₀, p₀, [symbol] ₀) over its main procedure P₀, where q₀= [symbol] φ₁ [symbol] P₀φ₂ [symbol] , φ₂ describes undesirable (error) states, and p₀ is undefined, since the initial query Q₀ does not have any parent queries.

The analysis component 112 will now be described in greater detail. The analysis component 112 comprises an intraprocedural analysis algorithm for manipulating queries, and such algorithm parameterizes the analysis framework 106. The analysis component receives a query Qᵢ in the Ready state, and the goal is to either compute a summary that answers the reachability question of Qᵢ or produce new queries that are to utilized to answer Qᵢ. The analysis component 112, as discussed above, can store procedure summaries that it computes in the data store 114. The analysis component 112 can also query the data store 114 for procedure summaries in order to avoid recomputing answers to queries. An exemplary formal specification of the analysis component 112 is set forth below:

Input: Qᵢ=(qᵢ, sᵢ, pᵢ, [symbol] ᵢ)

Output: Set of queries R.

Precondition: sᵢ=Ready.

Postcondition: R={Q′ᵢ ∪ C), where Q′ᵢ=(qᵢ, s′ᵢ, pᵢ, [symbol] ′) and:
1. (s′ᵢ=Done) [symbol] (C=0); and
2. (s′ᵢ ∈ {Blocked, Ready)) [symbol] ∀(qⱼ, sⱼ, pⱼ, [symbol] ⱼ) ∈ C·pⱼ=i [symbol] sⱼ=Ready.

The analysis component 112 receives a query Qᵢ=(qᵢ, sᵢ, pᵢ, [symbol] ᵢ) as input and returns a set of queries R. If the analysis component 112 successfully analyzes Qᵢ, it returns a copy Q′ᵢ of Qᵢ in a Done state (formula 1 of the above postcondition), and adds a summary that answers qᵢ to the procedural summaries 116. Otherwise, the analysis component 112 returns a copy Q′ᵢ of Qᵢ that is either in the Ready state or the Blocked state as well as a set of child sub-queries C of Q′ᵢ (formula 2 of the above postcondition). Each child sub-query Qⱼ=(qⱼ, sⱼ, pⱼ, [symbol] ⱼ) ∈ C is uniquely identified by its index j. If a query Qᵢ is in a Blocked state, the analysis component 112 can make no progress with Qᵢ and can only continue when one of its children returns a result (e.g., the child query is transitioned to a Done state and a corresponding summary is added to the procedural summaries 116). If Qᵢ is in the Ready state, the analysis component 112 can perform more processing on Qᵢ.

The analysis framework 106 interacts with the analysis component 112 as follows: first, the analysis component 112 attempts to return an answer to a query Qᵢ on some procedure Pⱼ by analyzing Pⱼ using summaries of the procedures called by Pⱼ that are stored in the procedure summaries 116. If the analysis component 112 is unable to locate appropriate summaries for such procedures, it transitions Qᵢ to the Blocked state and produces a number of new sub-queries C. The query Qᵢ remains in the Blocked state until one of its sub-queries has transitioned to the Done state (and, therefore, has a summary in the procedural summaries 116). The scheduler component 120 can schedule execution of the new sub-queries C across the multiple computing nodes 108-110, such that the query Qᵢ is processed in parallel.

For purposes of explanation, and without loss of granularity, an exemplary instantiation of the analysis framework 106 is set forth below. Other instantiations that facilitate parallelizing interprocecural top-down analysis are also contemplated and are intended to fall under the scope of the hereto-appended claims.

1: function FRAMEWORK(Program [symbol] , Query Q₀ = (q₀, s₀, p₀, O₀))

| | |
|---|---|
| 2: | QSet = {Q₀} |
| 3: | while [symbol] ∃(qᵢ, sᵢ, pᵢ, Oᵢ) ε QSet · sᵢ = Done [symbol] qᵢ = q₀ do |
| | MAP: |
| 4. | QSet′ ← [symbol] {ANALYSIS(Qᵢ)\|Qᵢ ε QSet [symbol] sᵢ = Ready} |
| 5. | QSet ← QSet′ ∪ {Qᵢ\|Qᵢ ε QSet [symbol] sᵢ ≠ Ready} |
| | REDUCE: |
| 6. | for all Qᵢ = (qᵢ, sᵢ, pᵢ, Oᵢ) ε QSet do |
| 7. | if sᵢ = Done then |
| 8. | if s_{P}_{ᵢ} = Blocked then set s_{P}_{ᵢ} to Ready |
| 9. | (*remove subtree rooted at Qᵢ from QSet*) |
| 10. | QSet ← QSet\Descendants(Qᵢ) |
| 11. | if there exists a must summary for q₀ in Procedural Summaries, |
| | then |
| 12. | return “Error Reachable” |
| 13. | else |
| 14. | return “Program is Safe” |

The analysis framework 106 receives as input the executable program 104 (a program [symbol] ) and a verification question Q₀ over the main procedure P₀ of [symbol] . The algorithm set forth above begins with a set of queries QSet that is initialized to the verification question (line 2). Each iteration (lines 3-10) is divided into 2 stages:
1) The MAP stage (lines 4-5): Applies the analysis component 112, in parallel, to each query Qᵢ ∈ QSet that is in the Ready state. Application of the analysis component 112 is shown in the algorithm as “ANALYSIS”. QSet′ is then assigned the union of all of the results returned by all calls to the analysis component 112. This is denoted by parallel union symbol [symbol] . The only resource shared by parallel instances of the analysis component 112 is the database that comprises the procedure summaries.
2) The REDUCE stage (lines 6-10): Removes redundant and Done queries from QSet. The function Descendants(Qᵢ) is used to denote the image of the transitive closure of the parent-child relation starting from Qᵢ. For every Qᵢ s.t.sᵢ=Done, all descendants of Qᵢ are garbage collected.

The above algorithm iterates, executing the MAP and REDUCE stages until q₀ is answered. For a query Qᵢ, when sᵢ=Done, the procedure summaries 116 either contain a must summary or a not-may summary that answers qᵢ. Therefore, when the analysis framework 106 exits the loop at line 3, it can be ascertained that there exists a summary that answers the reachability question q₀. If q₀ is answered by a must summary, then the analysis framework 106 outputs “Error Reachable”, as there is an execution to the error states defined in q₀. Alternatively, if q₀ is answered by a not-may summary, then the analysis framework 106 returns “Program is Safe”, since the not-may summary precludes any execution to an error state in q₀.

For purposes of explanation, an example corresponding to FIGS. 3 and 5 is set forth herein. In the second MAP stage 512, the analysis component 112 is applied to queries in the Ready state in QSet: Q_{foo} 504, Q_{bar} 506, and Q_{baz} 508. That is, in the second MAP stage 512, QSet is assigned as follows:

QSet′←ANALYSIS(Q_{foo})∪ ANALYSIS(Q_{bar})∪ ANALYSIS(Q_{baz})={Q′_{foo}} ∪ {Q′_{bar}} ∪ {Qᵣₒₒ, Q_{baz}}, and

QSet←QSet′ ∪ Qₘₐᵢₙ

It can be noted that ANALYSIS(Q_{foo}), ANALYSIS(Q_{bar}), and ANALYSIS(Q_{baz}) are computed in parallel. Subsequently, in the second REDUCE stage 516, Q′_{foo} and Q′_{bar} are in the Done state and, therefore, Qₘₐᵢₙ is set to the Ready state and Q′_{foo} and Q′_{bar} are removed from QSet.

Description of how a must-analysis, may-analysis, and may-must-analysis can be suitably modified in connection with the above-described analysis component 112 is now set forth. In an example, the analysis component 112 can be given a query Qₘ=(qₘ, sₘ, pₘ, [symbol] ₘ), where qₘ= [symbol] φ₁ [symbol] Pᵢφ₂ [symbol] and sₘ =Ready. A must-map and a may-map over procedure Pᵢ can be defined as follows:
Must-map: a must-map Ω: Nᵢ→2^{Σ}^{_{Pi}} maps locations n ∈ Nᵢ of Pᵢ to sets of states, representing an underapproximation of the set of reachable states at that location from states in φ₁ at nᵢ⁰. For each node n ∈ Nᵢ, Ωₙ can be used to denote Ω(n). Initially, Ωₙ_{ᵢ}_{^{o}}=φ₁, and for all

$$n ∈ \frac{{N}_{i}}{\{ {n}_{i}^{0} \}} , {Ω}_{n} = 0.$$

May-map: A may-map Π: Nᵢ→2²^{^{ΣPi}} maps locations n ∈ Nᵢ of Pᵢ to sets of states (partitions), which together represent an overapproximation of the set of states that can reach φ₂ at that location. For each node n ∈ Nᵢ, Πₙ can be used to denote Π(n). Initially, Πₙ_{ᵢ}_{^{x}}={φ₂, Σ_{P}_{ᵢ}\φ₂), and for every n ∈ Nᵢ\{nᵢ^{x}}, Πₙ={Σ_{P}_{ᵢ}}.

For a node n ∈ Nᵢ, sets of states Ωₙ and φₙ ∈ Πₙ are treated as formulas, and the notations Ωₙ^{G} and φₙ^{G} are utilized to denote, respectively, versions of Ωₙ and φₙ where all local variables are existentially quantified. Below, how different analyses populate such maps to answer the reachability question qₘ is described.

With respect to a must-analysis, such analysis explores a subset of the behaviors, or an underapproximation, of a given program, and is therefore useful for proving the presence of errors. In a must-analysis, the analysis component 112 can progressively propagate sets of reachable states along edges of the procedure Pᵢ. If at any point Ωₙ_{ᵢ}_{^{x}}∩φ₂≠0, then the postcondition φ₂ of qₘ is reachable from a state in φ₁, and, therefore, a must-summary that answers qₘ can be generated and stored in the procedure summaries 116. The verification object [symbol] ₘ for a must-analysis is the must-map Ω.

A difference from a typical must-analysis is the way in which the analysis component 112 can propagate reachable states over call statements. Given an edge e=(n, n′) ∈ Eᵢ such that λᵢ(e) is a call statement call Pⱼ, the analysis component 112 an encode reachability over this call as the reachability question [symbol] Ωₙ^{G} [symbol] PⱼΣ_{P}_{ⱼ} [symbol] , and can first check whether a must-summary that answers this question is available in the procedure summaries 116. If such a summary exists in the procedure summaries 116, the analysis component 112 uses the summary to update the set of reachable states Ω_{n′} at n′, the destination location of the call-edge e. Alternatively, if a must-summary is unavailable, the analysis component 112 can create a child query Qₖ, where qₖ= [symbol] Ωₙ^{G} [symbol] PⱼΣ_{P}_{ⱼ} [symbol] , and adds it to R (the set of sub-queries that the analysis component 112 returns to the analysis framework 106), which includes an updated copy of Qₘ. In contrast, a regular must-analysis would analyze the procedure Pⱼ and compute reachability information.

If the analysis component 112 successfully computes all reachable states, then the analysis component 112 terminates analysis of Qₘ. Since a must-analysis is not guaranteed to converge, however, the analysis component 112 can continue to analyze Qₘ up to some time limit or an upper-bound on the number of explored paths before it stops analysis and returns a set of child sub-queries R of Qₘ. This is to ensure that the MAP stage always terminates. When the analysis component 112 ceases its analysis of Qₘ, the state of the analysis component, which is the must-map Ω, is saved in [symbol] ₘ, so that the next time Qₘ is processed by the analysis component 112, it can continue exploration from the saved state [symbol] ₘ.

With respect to a may-analysis, such an analysis explores an overapproximation of behaviors of a program, and is therefore used to prove absence of errors. An exemplary goal of a may-analysis is to prove that no execution can reach a state in φ₂ at nᵢ^{x} from a state φ₁ at nᵢ⁰. For every edge e=(n, n′) ∈ Eᵢ, it can be assumed that there exists an abstract edge between every ψₙ ∈ Πₙ and every ψ_{n′} ∈ Π_{n′} (denoted by ψₙ→ₑψ_{n′}). The may-analysis proceeds by eliminating infeasible abstract edges in order to prove that φ₂ is unreachable. Eliminated abstract edges are stored in the set Ē, which is initially empty.

In an example, for edge e=(n, n′), λᵢ(e) is a simple statement, and that there exists an abstract edge ψ₁→ₑψ₂. A may-analysis checks if ψ₁ can reach a state in ψ₂ by taking an edge e. In case it cannot, ψ₁ is split into two partitions: ψ₁ [symbol] θ and ψ₁ [symbol] [symbol] θ, where pre(λᵢ(e),ψ₂) ⊂ θ and pre(λᵢ(e),ψ₂) is the preimage of the set of states ψ₂ with respect to the statement λᵢ(e). Since no state in ψ₁ [symbol] [symbol] θ an reach ψ₂, Ē is updated with the edge (ψ₁ [symbol] [symbol] θ,ψ₂). Intuitively, the partition ψ₁ is refined into a partition that may reach ψ₂, and another one may not.

If it is now assumed that λᵢ(e) is a call statement to some procedure Pⱼ, then the analysis component 112 encodes the reachability question [symbol] ψ₁^{G} [symbol] Pⱼψ₂^{G} [symbol] . If there exists a not-may summary [symbol] \hat{ψ}\hat{ψ₁} [symbol] Pᵢ\hat{ψ}\hat{ψ₂} [symbol] that answers this reachability question, then it can be ascertained that there are no executions from ψ₁ to ψ₂. Accordingly, the analysis component 112 splits ψ₁ into ψ₁ [symbol] θ and ψ₁ [symbol] [symbol] θ, where θ ⊂ \hat{φ}\hat{φ₁}, and adds (ψ₁ [symbol] [symbol] ν,ψ₂) to the set Ē. Otherwise, if there does not exist such a summary, the analysis component 112 can add a child query Qₖ, where qₖ= [symbol] ψ₁^{G} [symbol] Pⱼψ₂ [symbol] , to the set R.

As discussed, a may-analysis maintains the map Π and the set of eliminated edges Ē. Therefore, when the analysis component 112 returns Qₘ in a Ready or Blocked state, [symbol] ₘ is set to (Π, Ē). A may-analysis sets the query Qₘ to Done when all partitions of nᵢ⁰ intersecting with φ₁ cannot reach a partition of nᵢ^{x} intersecting with φ₂, where reachability is defined via abstract edges. As with a must-analysis, for fairness, the analysis component 112 can terminate analysis prematurely and store the state of the analysis in [symbol] ₘ.

With respect to a may-must-analysis, such an analysis combines a must-analysis with a may-analysis in order to efficiently find errors as well as prove their absence. In an exemplary embodiment, the analysis component 112 can employ testing, symbolic execution and abstraction to check properties of programs using a may-must analysis. Further, the analysis component 112 can employ interpolation-based model checking algorithms in connection with performing a may-must analysis, where symbolic executions to error locations can be undertaken to locate bugs and, in case of infeasible executions, use interpolants derived from refutation proofs to create an abstraction that eliminates a large number of potential counterexamples.

For a query Qₘ, a may-must analysis maintains Π, Ω, and Ē. Thus, if the analysis component 112 returns Qₘ in a Ready or Blocked state, it sets [symbol] ₘ to (Π, Ω, Ē).

A may-must analysis only analyzes an abstract transition ψ₁→ₑ ψ₂, where e=(n, n′) ∈ Eᵢ and λᵢ(e) is a call to some procedure Pⱼ, if Ωₙ∩ψ₁≠0 and Ω_{n′}∩ψ₂≠0. That is, only abstract transitions which have been reached by the must analysis, but not taken, are analyzed. Such transitions are known to those skilled in the art as “frontiers”.

A may-must-analysis, as instantiated in the analysis component 112, handles such transitions as follows:
1. If there exists a must summary [symbol] \hat{ψ}\hat{ψ₁} [symbol] P₁\hat{ψ}\hat{ψ₂} [symbol] that answers the query [symbol] Ωₙ^{G} [symbol] Pⱼψ₂^{G} [symbol] , then it can be ascertained that there exists an execution from Ωₙ to ψ₂ through Pⱼ, and, therefore, the analysis component 112 updates Ω_{n′} to be Ω_{n′} ∪ θ, where θ ⊂ \hat{ψ}\hat{ψ₂} and θ ∩ ψ₂≠0.
2. If there exists a not-may summary [symbol] \hat{ψ}\hat{ψ₁} [symbol] Pᵢ\hat{ψ}\hat{ψ₂} [symbol] that answers the query [symbol] Ωₙ^{G} [symbol] Pⱼψ₂^{G} [symbol] , then it can be ascertained that there are no executions from Ωₙ to ψ₂, and, therefore, the analysis component 112 splits region ψ₁ into ψ₁ [symbol] [symbol] θ and ψ₁ [symbol] θ, where θ ⊂ \hat{φ}\hat{φ₁} and [symbol] θ ∩ Ωₙ=0. Thus, the edge (ψ₁ [symbol] θ,ψ₂) is added to Ē.
3. If neither kind of summaries exist, then a child query Qₖ, where qₖ= [symbol] (Ωₙ [symbol] ψ₁)^{G} [symbol] Pᵢψ₂^{G} [symbol] , is added to R.

When undertaking a may-must analysis, the analysis component 112 continues processing a query Qₘ until a must summary is produced, a not-may summary is produced, or all abstract edges have been analyzed and child queries must be answered to continue processing. Similar to may- and must-analyses, the analysis component 112 can terminate analysis prematurely.

In summary, the analysis component 112 can be instantiated with various classes of analyses, which encompass a large number of existing algorithms.

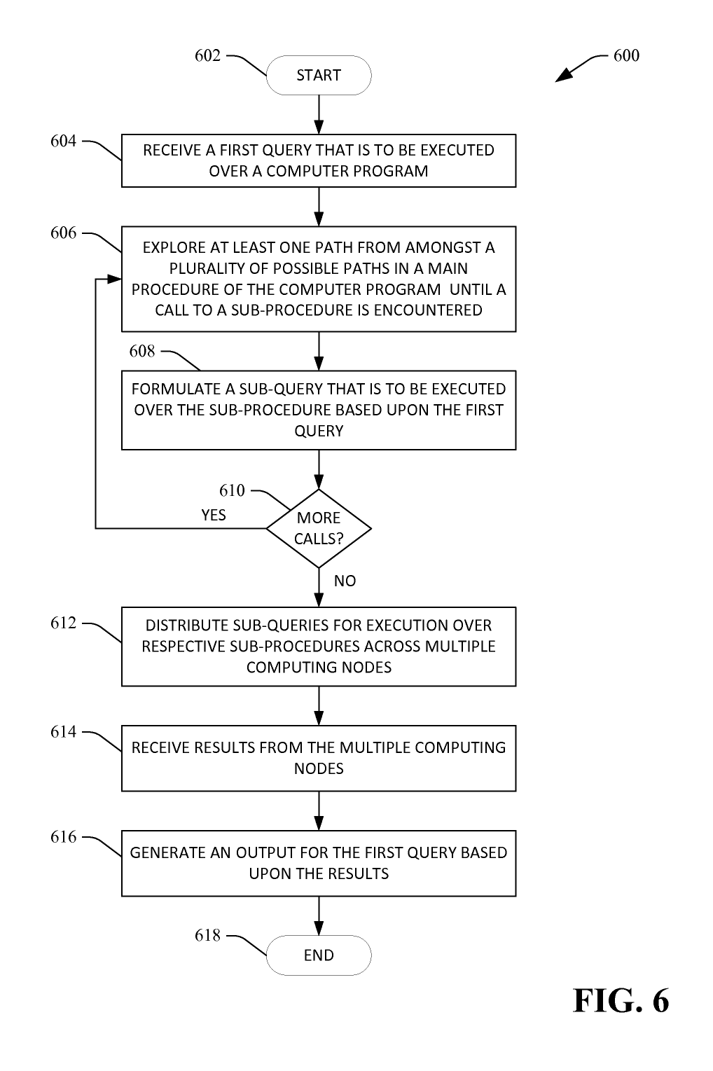

With reference now to FIG. 6, an exemplary methodology is illustrated and described. While the methodology is described as being a series of acts that are performed in a sequence, it is to be understood that the methodology is not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagating signal.

FIG. 6 illustrates an exemplary methodology 600 that facilitates paralyzing top-down interprocedural analysis of a computer program. The methodology 600 starts at 602, and at 604 a first query that is to be executed over a computer program is received. The computer program comprises a main procedure that calls a plurality of sub-procedures.

At 606, at least one path from amongst a plurality of possible paths in the main procedure is explored (forwards, backwards or some combination thereof) until a call to one of the sub-procedures is encountered. At 608, a sub-query that is to be executed over the sub-procedure is formulated based upon the first query. Such formulation is undertaken responsive to the call to the sub-procedure being encountered in the main procedure.

At 610, a determination is made regarding whether there are additional calls in the main procedure. If there are additional calls to sub-procedures in the main procedure, the methodology 600 returns to act 606, where the main procedure is further explored. If no additional calls reside in the main procedure, then at 612 the plurality of sub-queries are distributed for execution over respective sub-procedures across multiple computing nodes. At 614 results from the multiple computing nodes for the plurality of sub-queries are received, wherein the computing nodes generate such results by way of executing the plurality of sub-queries over the respective plurality of sub-procedures. It is to be noted that the computing nodes compute the results to the sub-queries in parallel. At 616, an output for the first query is generated based at least in part upon the results received from the multiple computing nodes. The methodology 600 completes at 618.

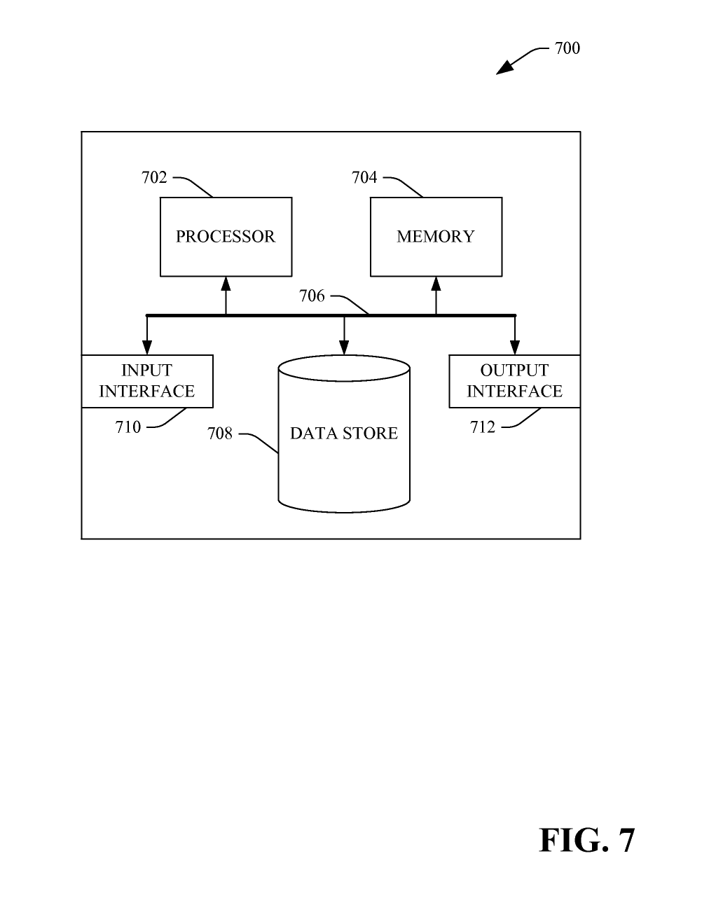

Now referring to FIG. 7, a high-level illustration of an exemplary computing device 700 that can be used in accordance with the systems and methodologies disclosed herein is illustrated. For instance, the computing device 700 may be used in a system that supports parellizing top-down interprocdural analysis. In another example, at least a portion of the computing device 700 may be used in a system that supports intraprocedural analysis. The computing device 700 includes at least one processor 702 that executes instructions that are stored in a memory 704. The memory 704 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store procedure summaries, queries, etc.

The computing device 700 additionally includes a data store 708 that is accessible by the processor 702 by way of the system bus 706. The data store may be or include any suitable computer-readable storage, including a hard disk, memory, etc. The data store 708 may include executable instructions, procedure summaries, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

Additionally, while illustrated as a single system, it is to be understood that the computing device 700 may be a distributed system. Thus, for instance, several devices may be in communication by way of a network connection and may collectively perform tasks described as being performed by the computing device 700.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method that facilitates parallelizing top-down interprocedural analysis of a computer program, the computer program comprising a main procedure that calls a plurality of sub-procedures, the method executed by a processor and comprising:
executing a first query over the main procedure of the computer program, wherein executing the first query over the main procedure comprises:
exploring at least one path from amongst a plurality of possible paths in the computer program until a call to a sub-procedure from amongst the plurality of sub-procedures is encountered;
responsive to the call to the sub-procedure being encountered, formulating a sub-query that is to be executed over the sub-procedure; and
repeating the exploring and formulating such that a plurality of sub-queries that are to be executed over the respective plurality of sub-procedures are formulated;
distributing the plurality of sub-queries across multiple computing nodes such that the plurality of sub-queries are executed over the respective plurality of sub-procedures by the multiple computing nodes in parallel;
receiving from the multiple computing nodes results generated via executing the plurality sub-queries over the respective plurality of sub-procedures; and
generating an output for the first query based at least in part upon the results received from the multiple computing nodes.

2. The method of claim 1, wherein the first query is a reachability query that is configured to ascertain whether a specified sub-procedure in the computer program is reachable.

3. The method of claim 1, wherein a computing node in the multiple computing nodes comprises a processor and memory that is accessible by the processor.

4. The method of claim 1, wherein a computing node in the multiple computing nodes comprises a processor core and memory that is accessible by the processor core.

5. The method of claim 1, wherein each computing node in the plurality of computing nodes has an intraprocedural analysis algorithm executing thereon, wherein the intraprocedural analysis algorithm is employed to execute each sub-query in the plurality of sub-queries over respective sub-procedures.

6. The method of claim 5, wherein the intraprocedural analysis algorithm utilizes one of an overapproximate analysis, an underapproximate analysis, or a combination thereof when exploring a sub-procedure.

7. The method of claim 1, wherein executing a sub-query over a respective sub-procedure comprises:
generating a summary of the sub-procedure; and
comparing a condition set forth in the sub-query with the summary of the sub-procedure, wherein the result output subsequent to executing the sub-query over the sub-procedure is based upon the comparing.

8. The method of claim 7, wherein executing the sub-query over the respective sub-procedure further comprises storing the summary of the sub-procedure in a data store that is accessible to each computing node in the plurality of computing nodes.

9. The method of claim 1, wherein executing a sub-query over a respective sub-procedure comprises:
accessing a data store that is accessible to each computing node in the plurality of computing nodes;
retrieving a summary of the sub-procedure from the data store; and
outputting a result for the sub-query based at least in part upon the summary of the sub-procedure retrieved from the data store.

10. A system, comprising:
a processor; and
a memory that comprises a plurality of components that are executed by the processor, the plurality of components comprising:
a receiver component that receives:
a computer-executable program from a data store, the computer-executable program comprising a main procedure and a plurality of sub-procedures; and
a main query that is desirably executed over the computer-executable program, the main query configured to analyze potential output states of the computer-executable program; and
a scheduler component that, responsive to receipt of the main query, assigns computing tasks to a plurality of computing nodes that are to be executed in parallel, wherein each computing node is assigned a computing task for a different respective sub-procedure in the computer-executable program, the computing tasks configured to collectively perform a top-down interprocedural analysis of the computer-executable program.

11. The system of claim 10, wherein the scheduler component, responsive to receipt of the main query, executes an intraprocedural analysis over the main procedure and outputs a plurality of sub-queries that correspond, respectively, to the plurality of sub-procedures, wherein the computing tasks assigned to the plurality of computing nodes comprise executing the sub-queries over the plurality of sub-procedures, respectively.

12. The system of claim 11, wherein at least one computing node from the plurality of computing nodes executes a sub-query over a sub-procedure assigned thereto and generates additional sub-queries, wherein the at least one computing node transmits the additional sub-queries to the scheduler component, and wherein the scheduler component assigns the additional sub-queries across computing nodes.

13. The system of claim 10, further comprising an output component that outputs a result for the main query based at least in part upon intraprocedural analyses performed over the sub-procedures by the plurality of computing nodes.

14. The system of claim 10, wherein at least one of the computing nodes comprises a processor core and memory that is accessible to the processor core.

15. The system of claim 10, wherein at least one of the computing nodes comprises a computing device that is in network communication with the scheduler component.

16. The system of claim 10, wherein the plurality of computing nodes are configured with an analysis component that performs map and reduce operations responsive to receipt of a query from the scheduler component.

17. The system of claim 10, further comprising a data store that is in network communication with the scheduler component and the plurality of computing nodes, wherein the data store comprises at least one summary for at least one sub-procedure in the plurality of sub-procedures, the at least one summary indicative of potential output states of the sub-procedure when the computer-executable program is executed by at least one processor, and wherein a computing node performs a computing task assigned thereto by the scheduler component by accessing the at least one summary from the data store and comparing the possible output states with data set forth in the computing task.

18. The system of claim 17, wherein another one of the plurality of computing nodes generated the at least one summary.

19. The system of claim 10, wherein a top-down interprocedural analysis comprises analyzing sub-procedures called by the main procedure using program context when the sub-procedures are called.

20. A computer-readable medium comprising instructions that, when executed by a processor, cause the processor to perform acts comprising:
receiving a main query for execution over a computer program, the computer program comprising a main procedure and a plurality of sub-procedures called in the main procedure;
responsive to receiving the main query for execution over the computer program, locating calls in the main procedure to the plurality of sub-procedures;
for each identified call to a sub-procedure, formulating a respective sub-query, the sub-query formulated to generate a result when executed over the sub-procedure that is employed when executing the main query over the computer program;
scheduling execution of the plurality of a plurality of sub-queries over the plurality of sub-procedures across multiple computing nodes such that the plurality of sub-queries are executed over the plurality of sub-procedures by the multiple computing nodes in parallel;
receiving results of execution of the plurality of sub-queries over the plurality of sub-procedures from the multiple computing nodes; and
outputting a result for the main query based at least in part upon the results received from the multiple computing nodes.
